(19) United States
(12) Patent Application Publication
(10) Pub. No.: US 2005/0109377 A1
(43) Pub. Date: May 26, 2005

(54) Removal of solids from tubes of a tube bundle heat exchanger

(75) Inventors: Volker Schliephake, Schifferstadt (DE); Wolfgang Leitz, Ludwigshafen (DE); Ulrich Hammon, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/989,277

(22) Filed: Nov. 17, 2004

(30) Foreign Application Priority Data
Nov. 17, 2003 (DE) 10353617.5

(51) Int. Cl. B01J 8/04

(52) U.S. Cl. 134/22.11

(57) ABSTRACT

The invention described herein relates to a process for removing solids from tubes of a tube bundle heat exchanger, wherein a drill driven by a drilling machine is inserted into a tube of the tube bundle heat exchanger and clears out solids present in the tube. In a first variant of the process according to the invention, the drill is a spiral drill and has, cut out in the outer casing of the drill, a spiral conveyor groove in which the solids particles loosened and isolated by the drill tip on insertion of the drill into the tube can be transported out of the tube. More preferably, the drill is a hollow drill 10 which is provided with a substantially circular drill tip 11 and has a central recess running along the rotational axis in the longitudinal direction of the drill and opening into the drill tip 11 at the free end of the drill. At the drill tip 11 are provided toothlike projections 12.

### FIELD OF THE INVENTION

The invention relates to a process for removing solids from tubes of a tube bundle heat exchanger, especially a process for removing catalyst material from tubes of a tube bundle heat exchanger.

### DESCRIPTION OF THE BACKGROUND

In the chemical industry, heat exchangers are used in a wide variety of processes in which heat exchangers are used in which a fluid whose temperature is to be controlled, especially a fluid which is to be heated or cooled, for example liquids, gases or liquid/gas mixtures, are passed through numerous tubes arranged in parallel and referred to as a tube bundle, which are flushed around by a suitable heat exchange medium. Depending on the type of the fluid passed through the tubes of the tube bundle, there may be fouling, baking-on or encrustations in the tubes in the course of operation, so that it is necessary to regularly clean the tubes. Typically, the tubes of heat exchangers are cleaned by means of liquids brought to a high pressure and sprayed out (high-pressure cleaning or hydroblasting). However, very persistent and compact contaminations can be removed only insufficiently by such high-pressure cleaning. In addition, internals such as deflecting plates, baffles, spirals, gas mixers, etc. are frequently arranged in the tubes of a tube bundle heat exchanger, which additionally complicates the cleaning of the tubes.

A special variant of tube bundle heat exchangers is that of tube bundle reactors which are used to carry out chemical reactions, for example to carry out exothermic and endothermic catalytic gas phase reactions, such as the preparation of phthalic anhydride (PA), acrylic acid, methacrylic acid (MMA), acrolein, maleic anhydride (MAA), glyoxal, phosgene, hydrocyanic acid or vinylformamide (VFA). Such catalytic gas phase reactions are usually carried out in tube bundle reactors over fixed bed catalysts. The tube bundle reactors consist typically of a reaction tube bundle disposed in a reactor casing and composed of numerous reaction tubes. The reaction tubes contain typically supported catalysts, coated catalysts, unsupported catalysts and/or structured packings composed of catalyst material which are arranged in a manner comparable to a static mixer. In the reaction tubes of the tube bundle, chemical reactions take place, in the course of which the heat exchange medium flushing around the tubes supplies or removes the heat of reaction. The tube bundle reactors used in the industrial production process may have diameters up to several meters and contain between approx. 1100 and 50 000 reaction tubes. The cleaning of the reaction tubes is correspondingly costly and inconvenient.

In the case of certain catalytic gas phase reactions, a reaction gas aftercooler designed as a tube bundle heat exchanger may also be disposed downstream of the tube bundle reactor, which further increases the cost and inconvenience of cleaning owing to the large number of tubes.

The European patent application EP-A 1 226 865 describes a process for removing spent catalyst material from a reaction tube. In the known process, a flexible or rigid suction hose is inserted into the reaction tube and catalyst material is sucked out of the reaction tube by a pressure reduced by the suction apparatus. In the variant of the known process, in which the rigid suction hose is used, the hose may have tips beveled at its free end inserted into the tube to loosen loosely caked or stuck catalyst material.

However, it is not possible by the process described in EP-A 1 226 865 to remove catalyst material from reaction tubes when the catalyst material is sintered together in large areas or is stuck together as a result of deposits which are formed in the course of the desired reaction carried out in the reaction tubes or in the course of undesired side reactions. The known process likewise meets its limits when the catalyst material is present no longer as particles, but rather as a block of greater or lesser persistency in the reaction tube, for example as a result of baking-on, changes in the shaped body or as a result of other modifications of the catalyst surface in the course of operation which might lead to the individual catalyst particles joining together.

### SUMMARY OF THE INVENTION

The technical problem on which the present invention is based is to provide a process for removing solids from tubes of a tube bundle heat exchanger, especially for removing catalyst material from reaction tubes of a tube bundle reactor, which allows rapid and reliable cleaning of the tubes even when the solids are no longer present in loose particulate form, but rather as solid blocks, and/or are adhering particularly firmly to the inner walls of the tubes.

This technical problem is solved by providing a process for removing solids from tubes of a tube bundle heat exchanger, comprising inserting a drill driven by a drilling machine into a tube of the tube bundle heat exchanger and to clear out solids present in the tube.

Advantageous developments of the process according to the invention are described in detail below.

### BRIEF DESCRIPTION OF THE FIGURES

The invention is illustrated in detail hereinbelow with reference to embodiments, illustrated schematically in the drawings appended, of preferred drill tips and with reference to the examples which follow.

In the drawings, FIGS. 1 to 4 are schematic partial views of the drill tips of preferred embodiments of the drills used in the process according to the invention.

FIG. 1 shows a substantially cylindrical hollow drill 10 which has a substantially circular drill tip 11. The drill tip 11 is provided with toothlike projections 12. In the drill of FIG. 1, the toothlike projections 12 are designed as substantially symmetrical triangles.

In contrast to this, FIG. 2 shows a variant of the drill of FIG. 1, in which the likewise substantially cylindrical hollow drill 20 is provided at the drill tip 21 with asymmetric triangular projections 22. The steeper flank 23 of the triangle 22 points in the direction of the drill which is symbolized by an arrow.

FIG. 3 shows a cylindrical hollow drill 30 whose drill tip 31 is provided with rectangular projections 32.

FIG. 4 shows a particularly preferred variant of a substantially cylindrical hollow drill 40 whose drill tip 41 has a conical section 44 narrowing toward the free end. Between the generatrix 45 and the central longitudinal axis 46 of the drill 40, a cone angle θ is formed. For a better overview, FIG. 4 does not show the toothlike projections provided on the drill tip in accordance with the invention.

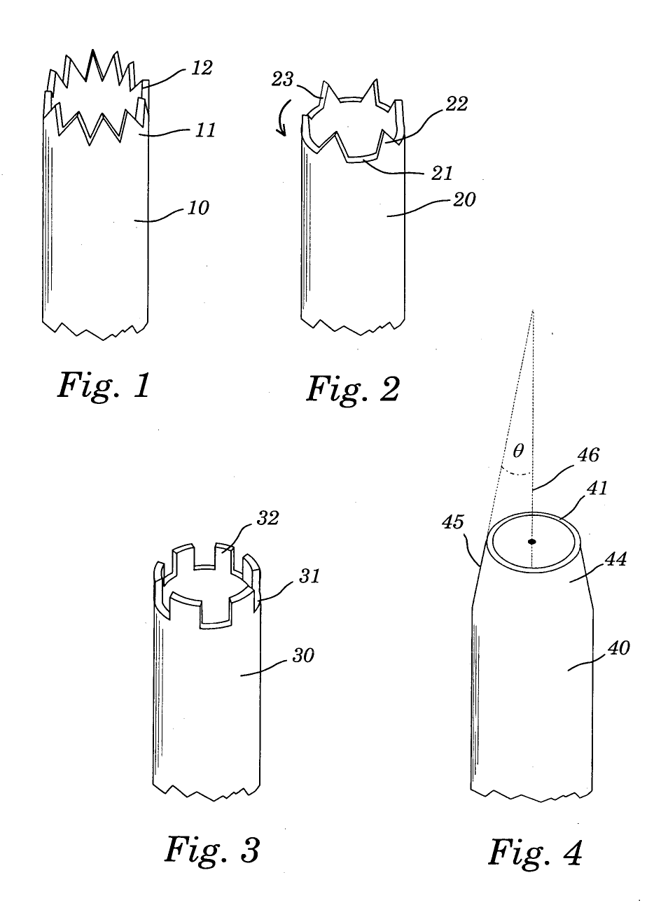

### DETAILED DESCRIPTION OF THE INVENTION

The invention is based on the idea of inserting a rotating drill driven by a drilling machine into the tubes, to be cleaned, of a tube bundle heat exchanger and clearing out the solids present in the tubes with the aid of the rotating drill, i.e. transporting them out of the reaction tube. Instead of a pure rotation, the drilling machine may also set the drill into rotation with an overlapping axial motion. The axial motion may be a continuous advance or a periodic motion back and forth generated by a mechanical or hydraulic percussion mechanism.

According to a first variant of the process according to the invention, the drill is a spiral drill and has, cut out in the outer casing of the drill, a spiral conveyor groove in which the solids particles loosened and isolated by the drill tip on insertion of the drill into the tube can be transported out of the tube. A spiral drill is more preferably used to clean reaction tubes of heat exchanger tubes which are charged with stonelike or ceramic material, for example with shaped catalyst bodies, coated shaped catalyst bodies or shaped bodies of ceramic inert material.

Advantageously, the spiral drill has a blunt drill tip in order to minimize the risk of damage to the inner walls of the tube bundle. Particular preference is given to using masonry drills instead of metal drills, which further reduces the risk of damage to the tubes.

However, spiral drills are not suitable when the tubes to be cleaned contain metallic internals, for example internals for increasing heat transfer such as deflecting plates or spirals.

According to a preferred embodiment of the process according to the invention, the drill is a hollow drill provided with a substantially circular drill tip. A hollow drill has a central recess which runs along the rotational axis in the longitudinal direction of the drill and opens into the drill tip at the free end of the drill.

This particular preferred embodiment of the invention allows highly differing reaction tubes and heat exchanger tubes to be cleaned, especially also those tubes which have metallic internals to improve heat transfer, for example metal spirals inserted into the reaction tubes. Owing to its central recess, the hollow drill used in accordance with the invention is actually capable of drilling around such internals, so that seizure of the drill tip on metal parts can be avoided.

The external diameter of the spiral or hollow drill is preferably from 10 to 95% of the internal diameter of the tube to be cleaned.

When the process according to the invention is carried out, the drill is set into rotation by means of the drilling machine, inserted into the tube and driven into the solids to be cleaned out, for example a caked catalyst mass. In the region of the end of the drill provided with the drill spindle of the drilling machine, a discharge window is preferably provided which communicates with the central recess running along the longitudinal axis of the hollow drill, from which the material comminuted by the drill tip can be discharged.

In the central recess of the hollow drill, internals, for example a helix, may also be provided, which supports the transport of the solids particles loosened by the drill tip toward the discharge window.

At the circular drill tip, toothlike projections are preferably provided which ease the breaking-up of the solids material present in the tubes. The toothlike projections may have any shapes. However, the toothlike projections preferably have a triangular and/or rectangular, for example square shape. The triangular projections may be designed as symmetric or asymmetric triangles. In the case of asymmetric triangles, the steeper flank of the triangle preferably lies in the direction of drill rotation.

The toothlike projections may be arranged in a series on the circular drill tip. According to one variant, the rings may also be arranged in a plurality of concentric series, in which case preference is given to an arrangement in from one to three rows.

In a particularly preferred variant of the process according to the invention, a hollow drill is used whose drill tip narrows substantially conically toward its free end. Such a narrowing drill tip reliably prevents damage to the tube walls. The angle θ formed between the axial longitudinal axis, i.e. the axis of rotation, of the hollow drill, and the conical casing of the drill tip is advantageously in the range from 0° to 20°, preferably in the range from 1° to 10° and more preferably in the range from 1.5° to 8°. Larger cone angles than 20° are less preferred, since solids particles are then trapped between the drill and the tube wall to a greater extent. It will be appreciated that a cone angle of 0° which is likewise explicitly included here corresponds to a “cone” having a cylindrical casing which does not narrow toward the tip.

The toothlike projections may be arranged in such a way that all teeth lie on a theoretical conelike surface whose generatrix forms a certain angle with the rotational axis of the drill. When this angle corresponds to the cone angle of the narrowing drill tip, the teeth are thus within the extension of the narrowing drill tip. However, the theoretical surface may also form an angle with the rotational axis which is greater or less than the cone angle of the drill tip, so that the teeth point inward or outward relative to the cone formed by the drill tip. It is also possible to use hollow drills which have a group of toothlike projections which lie on a first theoretical conelike surface, while a further group of toothlike projections is provided which lie on a second theoretical conelike surface, the generatrices of the two conelike surfaces forming different angles with the rotational axis. In such a variant, it is possible, for example, for successive teeth to be orientated in alternation parallel to the rotational axis (i.e. the angle between the generatrix of the theoretical surface and the rotational axis is 0°) or assumes an angle of 5° toward the interior with the rotational axis. In the case of hollow drills having a plurality of tooth row, this angle may also be different from tooth row to tooth row.

The preferred number of toothlike projections is preferably selected as a function of the outer circumference of the circular drill tip. Advantageously, from 1 to 6 teeth are provided per centimeter of external circumference.

The length, measured parallel to the longitudinal axis (rotational axis) of the drill, of the conically narrowing section of the drill tip corresponds preferably to from 0.1 to 3 times the external diameter of the drill, the external diameter being measured in the non-narrowing, substantially cylindrical section of the drill.

Preference is given to operating the drill at a rotation rate between 0 and 400 rpm, preferably between 200 and 280 rpm.

According to a particularly advantageous variant of the process according to the invention, the solids to be cleared out are treated with a solvent in the tubes of the tube bundle heat exchanger before the drilling machine is used. This variant of the process is suitable especially for removing adhered, coherent catalyst materials from reaction tubes. To this end, the reactor or heat exchanger is, as desired, closed or provided with a small orifice on its lower side. The tube space of the reactor is subsequently charged with a suitable solvent which can act on the solids in the tubes for a period of typically from 1 to 240 hours. To remove the action of the solvent, the solvent may be drawn off at the bottom of the reactor or heat exchanger and, in a circuit, introduced back to the top of the reactor or heat exchanger. It will be appreciated that the solvent circuit may also be operated in reverse direction. The amount of liquid pumped by circulation is preferably such that a superficial velocity of from 0 to 1 m/s is established in the reaction tubes. Superficial velocity refers to the velocity calculated from flow rate and tube cross section which would arise if the tubes were completely uncharged. Operation of the solvent circuit under elevated initial pressure also allows superficial velocities of above 1 m/s to be achieved. The solvents used are preferably water and more preferably an alkaline solvent such as dilute or concentrated sodium hydroxide solution, or dilute or concentrated potassium hydroxide solution.

Downstream of the process according to the invention, remaining alkali residues may be removed from the tubes of the tube bundle by flushing with water. Subsequently, the tubes are allowed to dry under ambient air or by blowing through heated air. Depending on the construction material of the tubes of the tube bundle, it may be desirable to remove any rust spots present, for example by sandblasting.

Finally, the invention also provides the use of a drilling machine, provided preferably with a spiral drill or a hollow drill, for removing solids from tubes of a tube bundle heat exchanger.

### EXAMPLES

The following Examples are illustrative of the invention are not meant to be limiting in any way.

### Comparative Example 1

A reactor having tubes of diameter 25 mm was charged at the upper end with cylindrical shaped bodies (inerts) of size 7 mm×7 mm×4 mm (external diameter×height×internal diameter). As a result of deposits which consisted of MoO₃ and cokelike constituents, the shaped bodies were caked together. The attempt to suck out these tubes by means of a suction tube which consisted of a plastics hose having, mounted at the tip, an 80 cm-long metal tube cut obliquely and having 85% of the reaction tube diameter was unsuccessful.

### Example 2

The reactor from Comparative Example 1 was cleaned by the process according to the invention.

To this end, a drilling machine was fitted with a hollow drill. The hollow drill had the following geometric data: steel shaft having a length of 400 mm, a diameter of 23 mm and a cone angle of 5°. The length of the cone was 30 mm. The drill had 15 teeth welded onto and ground into the circumference of the drill tip and made of stellite, which were designed as symmetrical triangles having a height of 3 mm. The drill was operated at a rotation rate of 220 to 280 rpm.

The caked layer could be removed without any problem. The time [minutes:seconds] for the drilling-through of caked layer per tube, depending on the degree of caking, was between 26 sec and 39 sec. The caked layer had a thickness of approx. 200 mm. The inerts below and the shaped catalyst bodies which followed could subsequently be sucked out.

### Examples 3-13

As example 2, but with different drill geometries. Examples 2 to 13 are summarized in Table 1 which follows. It was possible in all cases to clean the tubes. However, it can be seen that the use of drills having cone angles of less than 20° and tooth heights of less than 7 mm is preferred.

TABLE 1
Summary of examples 3-13

| | | | Cone | Cone | | Tooth | | |
|---|---|---|---|---|---|---|---|---|
| | Length | Diameter | angle | length | | height | Number of | Time |
| Ex. | [mm] | [mm] | [°] | [mm] | Tooth shape | [mm] | teeth | [min:sec] |
| 3 | 450 | 22 | 5 | 20 | sym. triangle | 3 | 15 | 0:34 |
| 4 | 450 | 20 | 5 | 20 | sym. triangle | 3 | 15 | 0:26 |
| 5 | 450 | 18 | 5 | 20 | sym. triangle | 3 | 15 | 0:38 |
| 6 | 450 | 23 | 10 | 10 | sym. triangle | 3 | 15 | 0:42 |
| 7 | 450 | 23 | 15 | 10 | sym. triangle | 3 | 15 | 1:02 |
| 8 | 450 | 23 | 20 | 10 | sym. triangle | 3 | 15 | >1:30 *) |
| 9 | 450 | 23 | 10 | 20 | sym. triangle | 5 | 12 | 0:22 |
| 10 | 450 | 23 | 10 | 20 | sym. triangle | 7 | 12 | 0:53 **) |
| 11 | 450 | 23 | 10 | 20 | assym. triangle | 5 | 12 | 0:29 |
| 12 | 450 | 23 | 10 | 20 | sawtooth | 5 | 12 | 0:28 |
| 13 | 450 | 23 | 10 | 20 | rectangle | 5 | 12 | 0:26 |
| 14 | 450 | 23 | 10 | 20 | rectangle | 3 | 12 | 0:34 |

*) frequent seizure of the drill
**) one tooth broken off

### Example 14

After deinstallation, a reaction gas aftercooler was found to be thoroughly fouled with hard material which had penetrated even into the tubes. The black fouling contained molybdenum and, in the course of heating to 800° C., lost 26.8% of its mass, which was interpreted as carbon (determined by the method of thermogravimetry).

Mechanical methods of cleaning were found to be unsuccessful or very time-consuming. Although cleaning was possible by drilling out the individual tubes by the process according to the invention, this took a very large amount of time. According to one variant of the process according to the invention, the reaction gas aftercooler was therefore closed at the bottom and filled with a 10% sodium hydroxide solution. The component was left to stand thus for 36 hours. After the sodium hydroxide solution had been allowed to drain out and water had subsequently been used to wash to neutrality, 87% of the fouled tubes could be cleaned with a wire brush. The remaining 13% could be rapidly removed from the tubes without any problem by drilling out with an inventive drill as described in example 2.

This application is based on German Patent Serial No. DE 103 53 617.5, filed on Nov. 17, 2003, and incorporated herein by reference.

1. A process for removing solids from tubes of a tube bundle heat exchanger, comprising inserting a drill driven by a drilling machine into a tube of the tube bundle heat exchanger and to clear out solids present in the tube.

2. The process according to claim 1, wherein the drill is a spiral drill.

3. The process according to claim 2, wherein the spiral drill has an external diameter from 10% to 95% of the internal diameter of the tube.

4. The process according to claim 1, wherein the drill is a hollow drill provided with a substantially circular drill tip.

5. The process according to claim 4, wherein the drill tip has toothlike projections.

6. The process according to claim 5, wherein the toothlike projections have a triangular and/or rectangular shape.

7. The process according to claim 6, wherein the toothlike projections are arranged in from one to three concentric rows on the drill tip.

8. The process according to claim 4, wherein a hollow drill is used whose drill tip narrows essentially conically toward its free end.

9. The process according to claim 8, wherein the conically narrowing section of the drill tip has a cone angle (θ) which is in the range from 0° to 20°.

10. The process according to claim 8, wherein the conically narrowing section of the drill tip has a cone angle (θ) which is in the range from 10 to 10°.

11. The process according to claim 8, wherein the conically narrowing section of the drill tip has a cone angle (θ) which is in the range from 1.5° to 8°.

12. The process according to claim 8, wherein the length of the narrowing conical section of the drill tip is from 0.1 to 3 times the external diameter of the drill.

13. The process according to claim 1, wherein the solids to be cleared out are treated in the tube with a solvent before the drilling machine is used.

14. The process according to claim 13, wherein the solvent is conducted through the tube in a circuit.

15. The process according to claim 1, wherein the tube bundle heat exchanger is a tube bundle reactor whose tubes contain a catalyst charge as solids.

16. The process according to claim 1, wherein the tube bundle heat exchanger has 100 to 50,000 tubes.

17. The process according to claim 1, wherein the drill is operated at a rotation rate from between 0 and 400 rpm.

18. The process according to claim 1, wherein wherein the drill is operated at a rotation rate from between 200 and 280 rpm.
